(19) United States
(12) Patent Application Publication
(10) Pub. No.: US 2008/0033073 A1
(43) Pub. Date: Feb. 7, 2008

(54) Polymer Films

(75) Inventors: Borje Sellergren, Schwerte (DE); Magdalena M. Tittirici, Berlin (DE)

Correspondence Address: YOUNG & THOMPSON, 745 SOUTH 23RD STREET, 2ND FLOOR, ARLINGTON, VA, 22202, US

(73) Assignee: MIP Technologies AB, Lund (SE)

(21) Appl. No.: 11/629,477

(22) PCT Filed: Jul. 1, 2005
(86) PCT No.: PCT/SE05/01097

§ 371 Date: Dec. 14, 2006

(30) Foreign Application Priority Data
Jul. 1, 2004 (SE) 0401739-8

(51) Int. Cl. C08F 265/02; C08K 5/16

(52) U.S. Cl. 523/122; 524/704; 524/732; 525/301; 526/204

(57) ABSTRACT

This invention relates to a non-supported (or free standing) cross linked polymer film obtainable by initiating the polymerization of one or several monomers at an interphase. The interphase may be between two immiscible liquids or at a liquid-gas, solid-gas or solid-liquid interphase. The polymer may be used to facilitate chemical reactions, for separation of substances, as a chromatographic stationary phase, as an adsorbent, in sensors or actuators. It may also be used for drug delivery, as a responsive valve or in artificial muscles. The invention also relates to a method for producing thin film polymers, wherein controlled radical polymerization (CRP) is used to produce a thin film cross-linked polymer at an interface where one of the phases (liquid, solid or gas) can be removed after polymerization and be replaced with another phase (liquid, solid or gas).

### TECHNICAL FIELD OF THE INVENTION

The present invention relates to polymers in the form of free standing films or layers. The films or layers can form the walls of a porous material or the shell of hollow spheres.

### BACKGROUND ART

The ability to control the structure and composition of materials on a nanometre scale is key to a number of advanced functions within diverse areas such as drug delivery, diagnostics and sensing, molecular electronics, catalysis, separations or in mimicking biological systems.¹ While nature has mastered this task, several synthetic so called “bioinspired” approaches have appeared leading to materials mimicking various morphologies found in nature such as molecules or particles with a core-shell structure, as membranes or vesicles. These can further incorporate other design principles used by nature such as compartmentalization and self assembly for such advanced functions as transport, molecular recognition or catalysis. Robust synthetic approaches for the design of materials with this level of structural control is therefore an important goal in materials science.

Concepts that have become particularly important in this endeavour are (A) grafting and controlled radical polymerization (CRP)¹ and (B) templated synthesis of materials.²

In (A) for instance, starting from an inorganic support of known morphology, nanocomposites can be synthesized by grafting an organic polymer film onto the surface. Grafting can be performed following essentially two different approaches, grafting to or grafting from (FIG. 1).³ In the former, the polymerization is initiated in solution and the growing radicals attach to the surface by addition to surface pendent double bonds. This implies that the polymer is coupled to the surface through reactions involving oligomers or polymers which effectively limits the density of grafted polymer. In the latter approach however the polymerization is started at the surface by surface immobilized initiator species or in situ generated radicals. This leads to reactions mainly between monomers and surface confined radicals resulting in a high density of grafted chains. By performing the grafting under conventional polymerization conditions, the thickness of the layers is difficult to control and significant propagation occurs in solution. Controlled radical polymerization (CRP) offers benefits in this regard. CRP distinguishes itself relative to conventional radical polymerization in respect of the life time of the growing radical. In the former this can be extended to hours allowing the preparation of polymers with predefined molecular weights, low polydispersity, controlled composition and functionality. By performing “grafting from” under CRP conditions, polymer films with controllable thickness, composition and structure can thus be prepared (FIG. 2). Furthermore, CRP with living character allows layer by layer grafting of different polymers with different function or character (e.g. polarity, molecular recognition or catalytic properties etc.).⁴ CRP can be performed by the following techniques¹: 1) Atom transfer radical polymerization (ATRP), relying on redox reactions between alkyl halides and transition metal complexes, (2) stable free radical polymerization (SFRP) making use of initiators (e.g. nitroxides such as 2,2,6,6,-tetramethylpiperidinyloxy or iniferters like dithiocarbamates or dithiuram disulfides) decomposing to one initiating radical and one unstable free radical, (3) degenerative transfer, based on the use of conventional initiators (e.g. azo-based initators like AIBN) and highly active transferable chain end capping groups such as dithioesters, the latter used in radical addition fragmentation chain transfer (RAFT) polymerization.

In (B) the concept of template synthesis allows on the other hand porous materials with different morphologies to be prepared. Here either an organic polymer may serve as a shape template for the synthesis of an inorganic porous network or alternatively an inorganic material serves as template for the synthesis of organic materials of defined morphology.⁵ In the latter, porous silica has been used as a sacrificial template for the synthesis of mesoporous organic polymer networks (FIG. 3).⁶ This occurs by filling the pore system of porous silica particles with organic monomers and initiator followed by polymerization to form an inorganic/organic composite materials and finally etching of the silica to yield a polymeric replica of the original pore system of the silica template. Thus, beaded network polymers with a narrow pore size distribution can be prepared. Alternatively, agglomerated nonporous silica nanoparticles may be used as template,² where the resulting organic polymer would constitute a replica of the interstitial void space of the silica agglomerates (FIG. 4).

An alternative to using solid templates is to perform the polymerization at the interface between two immiscible liquids or at the liquid-gas or solid-gas interphase (FIG. 5). Here amphiphilic initiators allow the polymerization to be initiated at the interface possibly under CRP conditions.

Only a few examples are known that combine the concepts in (A) and (B) above. Walt et al. used atom transfer radical polymerization (ATRP) to graft thick non-crosslinked polymer layers on porous silica.⁷ After etching away the silica template, hollow spheres remained with a relatively thick shell—thickness larger than 175 nm. Thin grafts would offer more interesting possibilities but have so far not been disclosed in the literature.

### SUMMARY OF THE INVENTION

This invention relates to a non-supported (or free standing) cross linked polymer film or layer obtainable by initiating the polymerization of one or several monomers at an interphase. These layers may form the walls of a porous material or the shell of hollow spheres. The interphase may be between two immiscible liquids or at the a liquid-gas, solid-gas or solid-liquid interphase.

The invention further refers to a method for producing thin film polymers characterized in that it uses controlled radical polymerization (CRP) to produce a thin film polymer at an interface where one of the phases (liquid, solid or gas) can be removed after polymerization and be replaced with another phase (liquid, solid or gas).

According to one embodiment the polymerization may be done by grafting under controlled radical polymerization conditions (CRP) of one or several monomers by the “grafting to” technique or by the “grafting from” technique.

The CRP may be performed by atom transfer radical polymerization (ATRP), relying on redox reactions between alkyl halides and transition metal complexes; by stable free radical polymerization (SFRP) making use of initiators or iniferters decomposing to one initiating radical and one stable free radical or by radical addition fragmentation chain transfer (RAFT) polymerization.

According to another embodiment this invention relates to the combination of approaches (A) and (B) (see Background art) to generate defined nanostructures. This presents a number of new and previously unexplored opportunities (FIG. 6). Especially cross-linked polymers may form walls of a porous material or the shell of hollow spheres. For instance, grafting a thin film onto a disposable support and subsequently removing the support would leave behind a porous material with thin walls (FIG. 6A). If the walls are made very thin (e.g. 1-5 nm), these materials exhibit no permanent porosity and instead behave as gels with high swelling factors. In the swollen state they should ideally exhibit a 2-fold larger surface area than the precursor support material. By analogy with hydrogels, such gel-like materials could further exhibit stimulus-response functions, e.g. a chemically or physically triggered change in swelling.⁸ If the grafting is performed under CRP conditions, multiple layers may be grafted exhibiting different composition, structure and function. After removing the support the innermost layer (the first grafted layer) would be exposed within walls which thus would contain two non-equivalent surfaces (FIG. 6B). In a simple case the polarity of the layers can be different, layer (a) can be composed of a hydrophilic polymer whereas layer (b) can be composed of a hydrophobic polymer. After support removal, a porous material with walls containing one hydrophobic and one hydrophilic surface would be obtained. Depending on the support material morphology these thin walled materials can be further designed to exhibit a high surface area. This could be used to enhance the efficiency in liquid-liquid two phase extractions where the hydrophobic pores would be filled with the organic phase and the hydrophilic with the aqueous phase.

Another possibility using this layer by layer approach would be to facilitate chemical reactions or catalyze chemical reactions within the layer or film. This can occur either through reactions occurring at the oil/water interface combined with facilitated transport of the reactants or products and/or incorporation of catalytically active groups within the thin walls. Both of these approaches would benefit from the potentially high surface area of the thin walls, the short diffusion paths through the walls and the polarity difference between the surfaces. Thus in the case of one nonpolar surface exposed to an organic solvent and one polar exposed to water (see FIG. 6B) interfacial reactions can be performed with a higher efficiency than is possible using classical two phase reactions in liquid-liquid two phase systems. This can for instance be the hydrolysis of a lipophilic ester (or amide) to hydrophilic products being the corresponding alcohol (or amine) and acid. The reactant(s) easily adsorb at the non-polar surface whereas the product will be released from the polar surface into the aqueous phase (FIG. 6C). The catalysis of the reverse condensation reaction is also possible.

In one embodiment of the invention receptor or catalytic sites are incorporated in the walls through molecular imprinting techniques. Robust molecular recognition elements can be produced by the copolymerization of commodity monomers, e.g. methacrylic acid (MAA), 2- or 4-vinylpyridin (VPY), N,N-diethylaminoethylmethacrylate (DEAEMA) and methacrylamide (MAAM), with crosslinking monomers (e.g. ethyleneglycol dimethacrylate (EDMA), divinylbenzene (DVB), trimethylolpropanetrimethacrylate (TRIM), pentaerythritoltriacrylate (PETRA), methylenebisacrylamide (MBA)) in presence of a binding site forming template (widely defined as: methylenebisacrylamide (MBA)) in presence of a binding site forming template (widely defined as: ions, small molecules such as drugs, pesticides, amino acids, macromolecules such as peptides, proteins (eg antibodies,antigens), DNA bases, DNA oligomers or nucleic acids, carbohydrates, microorganisms such as viruses, bacteria, cells, or crystals (FIG. 7).⁹ This method of preparing tailor-made molecular recognition elements goes under the name of molecular imprinting. This approach has been used to generate porous materials exhibiting pronounced recognition for a large variety of template structures. Alternatively, the sites may be designed by imprinting techniques to display catalytic activity for a specific chemical reaction.

Unfortunately, conditions that are optimal to generate the templated binding sites at a molecular level often lead to undesirable properties at the nano- or microscopic level, i.e. undesirable particle and pore sizes, surface areas and swelling properties. Imprinted materials with a homogenous morphology have been produced by suspension polymerization, emulsion polymerization, dispersion polymerization or precipitation polymerization. One issue with all of these techniques is that the morphology of the resulting products is very sensitive to small changes in the synthesis conditions. Even under strictly controlled synthesis conditions, a simple change of template may require a complete reoptimization of the conditions in order to achieve a given morphology. Furthermore, most of these procedures are limited with respect to the type of monomer and solvent that can be used for the polymerization

One way to circumvent these problems is to graft the polymers on the surface of preformed solid phase or support materials, e.g. on silica or on organic polymer supports. The grafting can be performed according to the “grafting to” or the “grafting from” approach (see above). The latter approach has recently been shown to result in promising improvements of the imprinted polymers both with respect to the production process as well as with respect to the molecular recognition and kinetic properties of the materials¹⁰ (see U.S. Pat. No. 6,759,488).

In another approach (the hierarchical imprinting approach) porous silica is used as a mould in order to control the particle size, shape and porosity of the resulting imprinted polymer.⁶ The template can either be immobilized to the walls of the mold or the template can be simply dissolved in the monomer mixture. The pores are here filled with a given monomer/template/initiator mixture, and after polymerization the silica is etched away and imprinted polymer beads are obtained exhibiting molecular recognition properties. From a production stand point this procedure has the advantage of being simple and of giving a high yield of useful particles with predefined and unique morphology.

Structural control of both the pore system and the binding sites are of particular importance in the case of larger template molecules which can only access the surface of larger mesopores or macropores. Approaches to confine the binding sites to highly accessible domains of the polymer matrix are therefore being assessed. In the hierarchical imprinting approach, this is achieved by controlling the porosity of the solid mould which in turn may allow substructures of larger target molecules to be recognized by the surface exposed sites (FIG. 8).¹¹

### BRIEF DESCRIPTION OF THE DRAWINGS

FIG. 1. The principles of grafting a polymer “to” a surface (A) or “from” a surface (B). The former technique relies on surface attached groups reactive with the growing polymer chains whereas the latter on surface immobilized initiators.

FIG. 2. Techniques to perform controlled radical polymerization exemplified by the use of iniferters immobilized on porous silica supports.

FIG. 3. Principle of templated material synthesis using porous silica as a disposable mold.

FIG. 4. Use of agglomerated nonporous silica nanoparticles as template for the synthesis of a porous polymeric material. After etching of the silica particles, the resulting polymer constitutes a replica of the interstitial void space of the silica agglomerates.

FIG. 5. Polymerization at the interface between two immiscible liquids or at the liquid-gas or solid-gas interphase using amphiphilic initiators.

FIG. 6. Combination of CRP, here exemplified by the use of the immobilized iniferter benzyl-N,N-diethyldithiocarbamate, and template synthesis to generate defined nanostructures with various functions. (A) Grafting of a thin film onto a disposable support followed by removal of the support results in a thin walled material. (B) Layer by layer grafting of polymer under CRP conditions giving multiple layers exhibiting different composition, structure and property (e.g. polarity). (C) Use of material as in (B) to catalyze the reaction of a lipophilic reactant or substrate to yield a polar product. One example is the hydrolysis of a lipophilic ester to hydrophilic products being the corresponding alcohol and acid.

FIG. 7. Principle of molecular imprinting.

FIG. 8. Principle of hierarchical imprinting using solid phase synthesis products as templates.

FIG. 9. Adsorption isotherms of D- and L-phenylalanine anilide (PA) obtained for the adsorption on an L-PA imprinted thin walled MIP and a corresponding nonimprinted gel (blank) prepared as described in (A) Example 2 and 10 (normal system); (B) Example 3 and 10 (hydrophilic system). (C) and (D) shows the isotherms obtained on the precursor composite materials corresponding to (A) and (B) respectively.

FIG. 10. Enantioselective swelling (given as the average particle diameter) obtained by adding incremental amounts of each enantiomer to a given amount of polymer prepared as described in Example 3 and 10.

FIG. 11. Scanning electron micrographs of a crossection of a thin walled polymer particle prepared according to Example 2 and 10.

FIG. 12. Example of structures of initiators used for the “grafting from” experiments at liquid/liquid or liquid/gas interphases (A) or solid/liquid or solid/gas interphases (B).

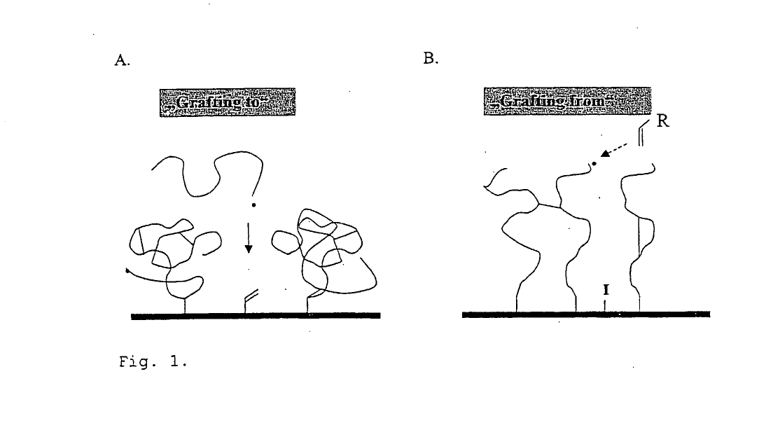

### DETAILED DESCRIPTION OF THE INVENTION

This invention refers to a polymeric thin film which can be free standing, supported or form the walls of a porous gel or vesicle. The polymer can be cross-linked and exhibit molecularly imprinted binding or catalytic sites. This thin film system can be used as adsorbent, chromatographic stationary phase, in sensors or actuators, to facilitate transfer of a given compound from one phase to another (liquid, solid or gas), to catalyze chemical reactions, as drug delivery vehicles, as screening elements in drug discovery or in other therapeutic applications. It can further be designed to exhibit stimulus-response functions for use in drug delivery, sensors, in responsive valves, or in artificial muscles.

The invention further refers to a method for producing thin film polymers characterized in that it uses controlled radical polymerization (CRP) to produce a thin film polymer at an interface where one of the phases (liquid, solid or gas) can be removed after polymerization and be replaced with another phase (liquid, solid or gas). The CRP can be performed by any of the established methods by ATRP, SFRP or RAFT mediation. The polymerization can further be performed in presence of a template or a monomer-template assembly to create recognition or catalytic sites in the polymer. The polymerization is preferably performed by the grafting from process where the free radical initiator is confined to the said interphase.

Examples of liquid/liquid interphases according to above are those formed by mixing an aqueous phase with a non-miscible organic solvent, an aqueous phase with another aqueous phase made non-miscible by the use of additives (e.g. polyethyleneglycols and dextrans) or those formed by mixing two non-miscible organic solvents. The interphase surface area, involving two liquid phases or one liquid and one gas phase, can be tuned by the addition of amphiphilic surface active agents resulting in droplets of different sizes (FIG. 5). The initiators are here preferably amphiphilic inititators which due to the amphiphilic nature enrich at the interphase. This allows polymer films to be grafted from this interphase by the addition of monomers in one or both of the liquid phases.

For thin films prepared at an interphase separating a solid and a liquid phase according to the above solid phase may consist of porous or non-porous, inorganic or organic materials. Examples of inorganic materials are solids such as oxides based on silicon (e.g. silica, porous glass), titanium, aluminum (alumina) and zirconium. Examples of organic materials are network organic polymers such as those based on polymethacrylates, polyacrylates, polystyrene or biopolymers (e.g. agarose or dextran). The solid can further be planar or nonplanar. The former include flat surfaces based on silicon (oxidized or non-oxidized), glass, MICA, gold or other metal surfaces. The initiator is in this case confined to the interphase by immobilization either covalently or non-covalently as previously described¹⁰. The grafting is performed by the addition of monomers in the liquid phase contacting the solid material. The liquid can be aqueous or non-aqueous.

For thin films prepared at an interphase separating a solid and a gas phase according to above the same kind of solid materials and initiators can be used as for the liquid/solid polymerizations. In this case the monomers are transported to the interphase via the gas phase.

Removal of the solid phase is preferably performed through base hydrolysis or fluoride treatment (e.g. for silica).

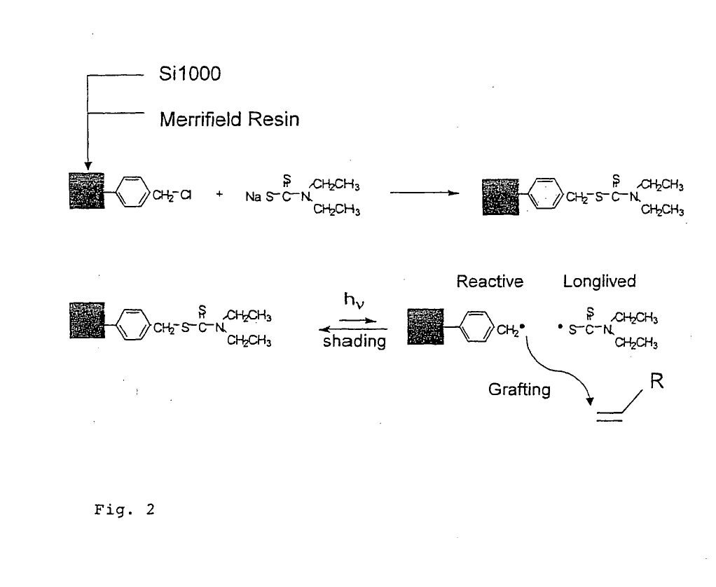

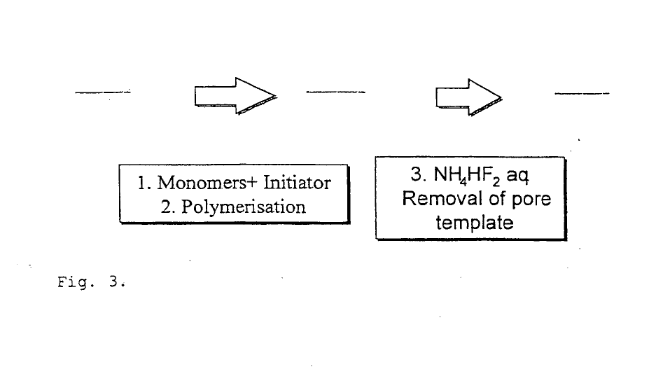

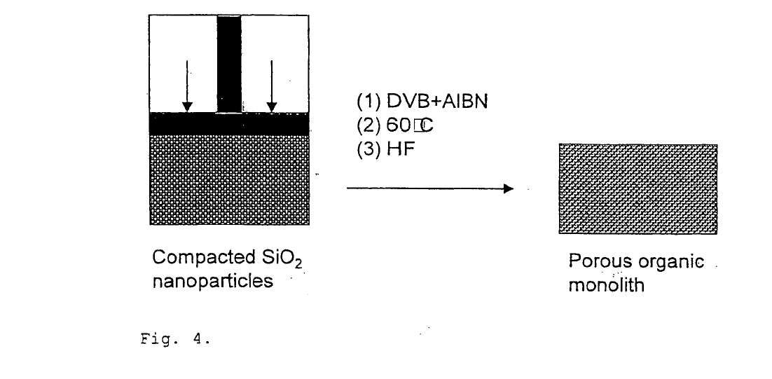

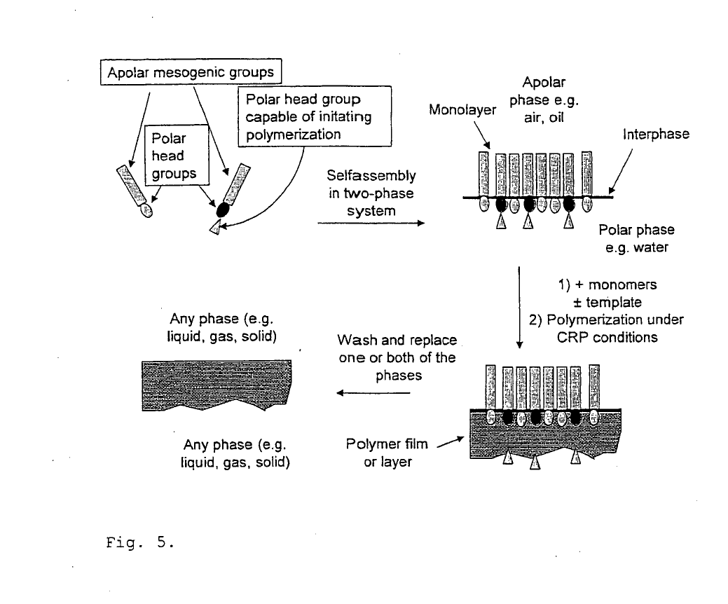

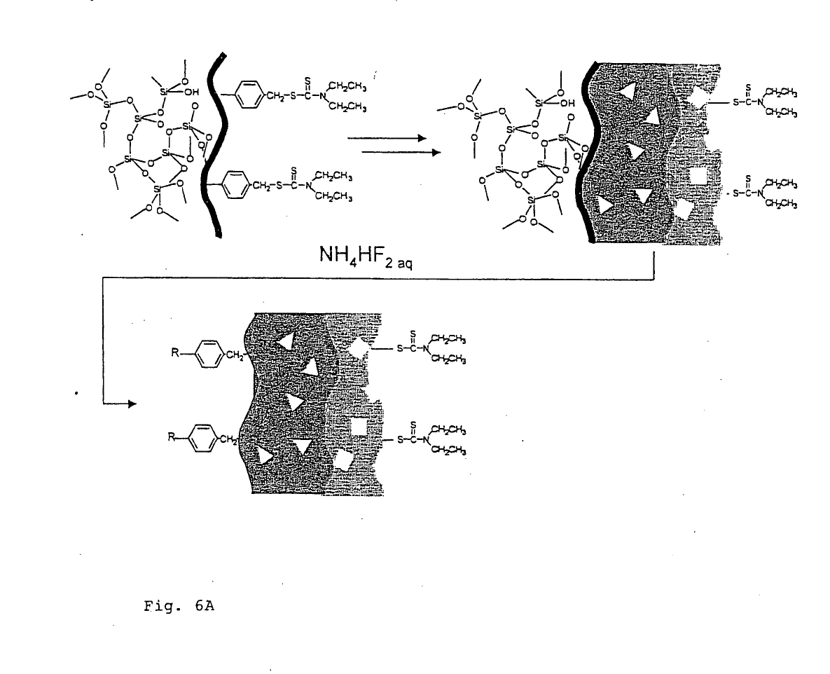

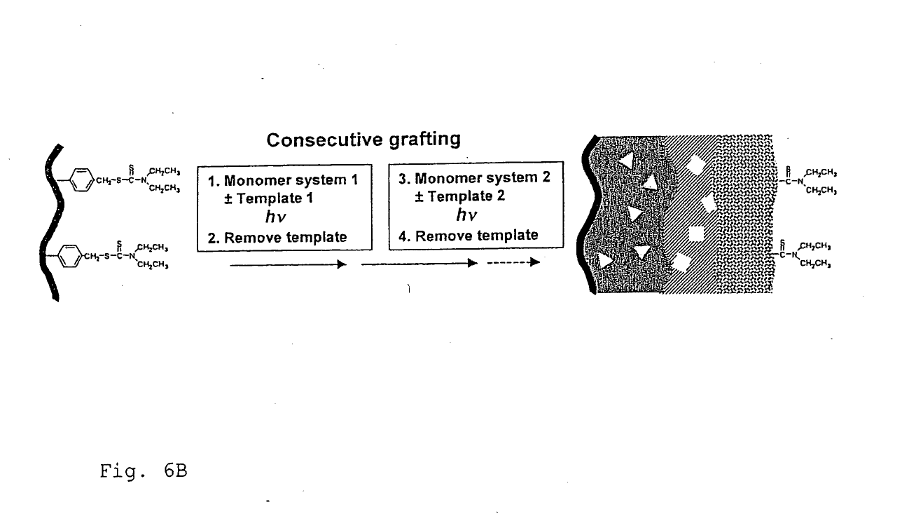

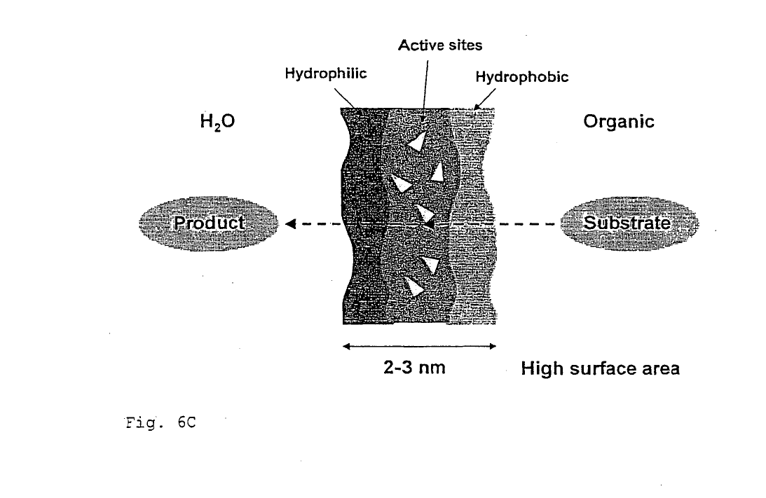

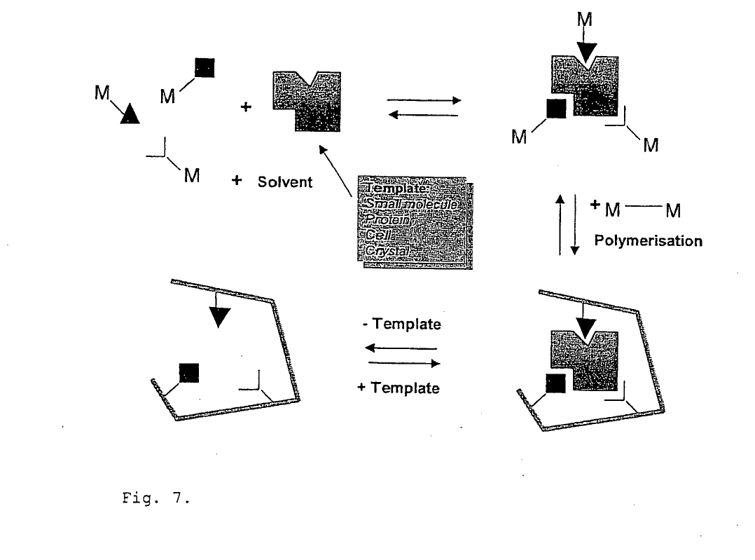

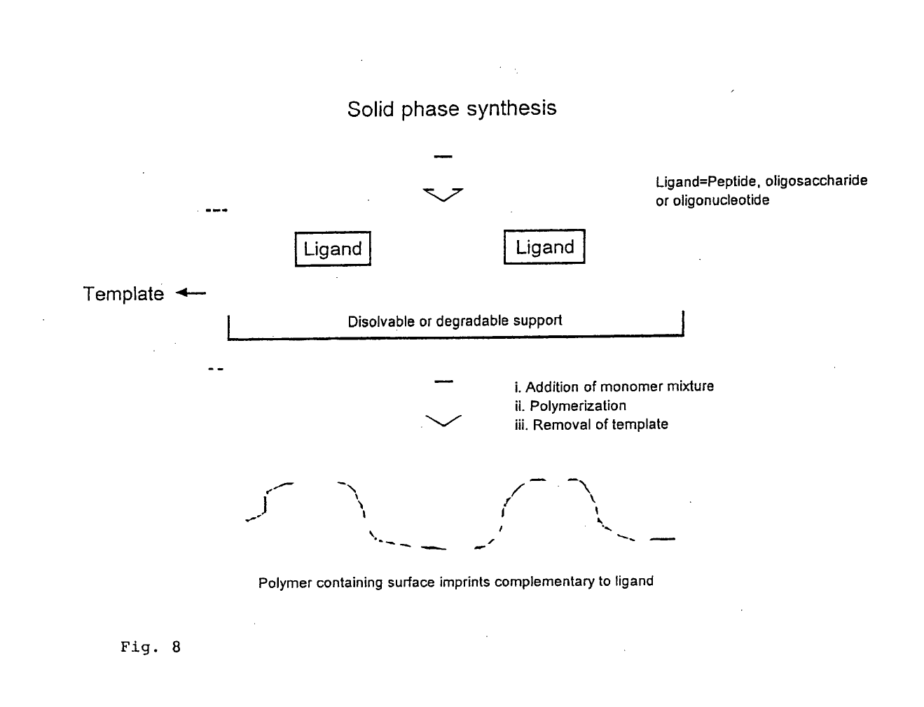

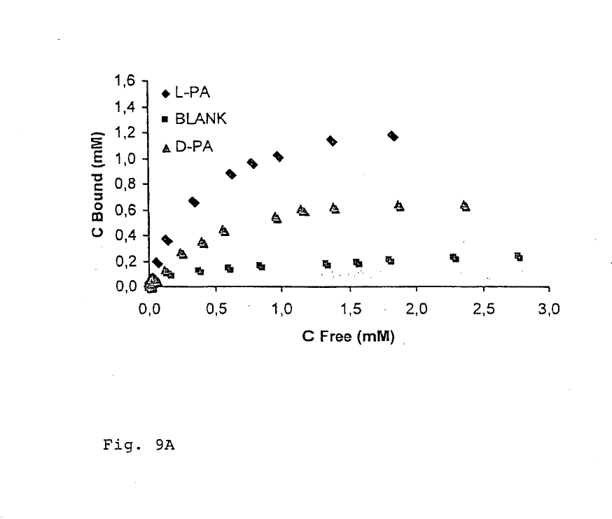

The grafting from the interphase may make use of initiators of structures shown in FIGS. 2, 5, 6 and 12. A general structure can be drawn as: R₁-R₂—I,
where in the case of polymerization at the liquid/liquid or liquid/gas interphases R₁=a lipophilic and possibly a mesogenic group e.g. an alkyl chain of the general structure H₃C—(CH₂)ₙ— where n=1-30, R₂=charged group e.g. a quarternary ammonium group of the general structure —NR₃R₄⁺— where R₃ and R₄ are alkyl groups of the general structure H₃C—(CH₂)ₙ— where n=1-30, an amidinium group of the general structure —NH—C(NH₂)⁺—, or a phosphate diester group (—O—P(═O)(—O)—O—⁻).
In the case of polymerization at the solid/liquid or solid/gas interphases, R₁=linker group providing covalent or noncovalent attachment of the initiator to the surface. R₂=optional spacer group.
For both of the above cases I=initiating group capable of generating free radicals. This can be an azo group (—R₃—N═N—R₄) or a peroxide (—R₃—O—O—R₄) where R₃ and R₄ can be any substituent group leading to dissociation energies suitable for thermal or photochemical polymerization. In the case of ATRP it is preferably an alkyl halide of the general structure —RX where R is any aliphatic substituent. In the case of SFRP using iniferters, I is preferably a dithiocarbamate of the general structure —S—C(═S)NR₁R₂ where R₁ and R₂ can be any substituent. For SFRP using nitroxides the general structure of the initiator is —O—NR₁R₂ where R₁ and R₂ can be any substituent.

In the case of CRP via the use of RAFT agents, the RAFT agent preferably is a dithioester of the general structure R₁—S—C(═S)—R₂ where R1 and R₂ are chosen in order to favor chain transfer reactions, etc.

In the case of CRP (ATRP, SFRP via nitroxides or iniferters, RAFT controlled polymerizations) the polymerization may be living in the sense that it is possible to graft a second polymer layer onto the first one.

Any monomer polymerizable via radical polymerization may be used for grafting the polymer films. These include commodity monomers e.g. methacrylic acid (MAA), acrylic acid, 2- or 4-vinylpyridin (VPY), N,N-diethylaminoethylmethacrylate (DEAEMA), acrylamide, methacrylamide (MAAM), vinylpyrrolidone, styrene, cyanostyrene, acrylonitrile, 2-hydroxyethylmethacrylate, vinylimidazole with crosslinking monomers e.g. ethyleneglycol dimethacrylate (EDMA), divinylbenzene (DVB), trimethylolpropanetrimethacrylate (TRIM), pentaerythritoltriacrylate (PETRA), methylenebisacrylamide (MBA).

For the molecularly imprinted films any template may be added, template being widely defined as: small molecule, macromolecule, virus, cell, microorganism or crystal.

While the invention has been described in relation to certain disclosed embodiments, the skilled person may foresee other embodiments, variations, or combinations which are not specifically mentioned but are nonetheless within the scope of the appended claims.

All references cited herein are hereby incorporated by reference in their entirety.

The expression “comprising” or “include” as used herein should be understood to include, but not be limited to, the stated items.

The invention will now be described in more detail with reference to a number of non-limiting examples:

### EXAMPLE 1

Imprinted (MIP) and Nonimprinted (MP) Polymer-Silica Composites Using Immobilized Azo-Type Initiators and RAFT Polymerization.

Porous Si100 particles (average pore diameter (d)=10 nm) were modified with azoinitiator in two steps,¹² before grafting of a polymer film on its surface. Prior to the first modification step, the silica surface was rexydroxylated according to standard procedures. This is known and result in a maximum density of free silanol groups of ca. 8 μmol/m². A maximum of half the silanol groups reacted with (3-aminopropyl)triethoxysilane (APS) in the first silanization steps. The subsequent step was the attachment of azobis(cyanopentanoic acid) ACPA. On the basis of the increase in nitrogen content, a maximum area density of 1.5 μmol/m² for the azo-initiator.

1 g of this azo-modified silica particles was suspended in a polymerization mixture containing L-phenylalanine anilide (L-PA) (0.240 g), RAFT agent (2-phenylprop-2-yl-dithiobenzoate) (0.2 g), MAA (0.68 mL) and EDMA (7.6 mL) dissolved in 11.2 mL of dry toluene. After sealing, mixing and purging the mixture with nitrogen,:polymerization was initiated by UV-irradiation at 15° C. and allowed to continue for either 60, 90, 120 or 240 minutes, respectively, with continuous nitrogen purging. After polymerization, the samples were extracted with methanol using a Soxhlet apparatus for 24 h. Non-imprinted control polymer composites (NIP) were prepared as described above but without addition of the template.

### EXAMPLE 2

Imprinted (MIP) and Nonimprinted Polymer-Silica Composites Using Iniferter-Type Initiators

Prior to the first modification step, the silica surface was rexydroxylated according to standard procedures. This is known to result in a maximum density of free silanol groups of ca. 8 μmol/m². A maximum of half the silanol groups reacted with p-(chloromethyl)phenyltrimethoxy silane in the first silanization steps. The subsequent step was the conversion of the benzylchloride groups to the corresponding diethyldithiocarbamate by reaction with sodium-N,N-diethyldithiocarbamate. On the basis of the increase in nitrogen and sulphur content, a maximum area densities of 0.75 μmol/m² for the iniferter was calculated.

1 g of iniferter-modified silica particles was suspended in a polymerization mixture containing L-PA (0.240 g), MAA (0.68 mL) and EDMA (7.6 mL) dissolved in 11.2 mL of dry toluene. The polymerization was carried out as described in example 1.

Non-imprinted control polymer composites (NIP) were prepared as described above but without addition of the template.

### EXAMPLE 3

Imprinted (MIP) and Nonimprinted Hydrophilic Polymer-Silica Composites Using Iniferter-Type Initiators

1 g of iniferter-modified silica particles, obtained as described in Example 2, was suspended in a polymerization mixture consisting of L-PA (0.04 g), MAA (0.172 mL), HEMA (0.49 mL) and EDMA (1.26 mL) dissolved in 3 mL of dry 1,1,1-trichloroethane. The polymerization was carried out as described in example 1.

Non-imprinted control polymer composites (NIP) were prepared as described above but without addition of the template.

### EXAMPLE 4

Layer by Layer Enantiomer Imprinted Polymer-Silica Composites by Controlled Radical Polymerization (CRP)

1 g of iniferter-modified silica particles, obtained as described in Example 2, was suspended in a polymerization mixture consisting of L-PA (0.04 g), MAA (0.68 mL) and EDMA (7.6 mL) dissolved in 11.2 mL of dry toluene. The polymerization was carried out as described in example 1.

After polymerization the particles were Soxhlet extracted, dried and subsequently immersed in second prepolymerization mixture consisting of D-PA (0.04 g), MAA (0.68 mL) and EDMA (7.6 mL) dissolved in 11.2 mL of dry toluene. The second layer was grafted as described for the first grafted layer.

### EXAMPLE 5

Layer by Layer Imprinted and Nonimprinted Polymer-Silica Composites by Controlled Radical Polymerization (CRP)

1 g of iniferter-modified silica particles, obtained as described in Example 2, was suspended in a polymerization mixture consisting of L-PA (0.04 g), MAA (0.68 mL) and EDMA (7.6 mL) dissolved in 11.2 mL of dry toluene. The polymerization was carried out as described in example 1.

After polymerization the particles were Soxhlet extracted, dried and subsequently immersed in second prepolymerization mixture consisting of 2-hydroxyethylmethacrylate (HEMA) in toluene. Grafting of the second layer was performed as described for the first grafted layer.

### EXAMPLE 6

Layer by Layer Hydrophilic and Hydrophobic Polymer-Silica Composites by Controlled radical Polymerization (CRP)

1 g of iniferter-modified silica particles, obtained as described in Example 2, was suspended in a polymerization mixture consisting of pentaerythritoltriacrylate (8 mL) dissolved in 10 mL of dry toluene. The polymerization was carried out as described in example 2.

After polymerization the particles were Soxhlet extracted, dried and subsequently immersed in second prepolymerization mixture consisting of divinylbenzene (DVB) in toluene. Grafting of the second layer was performed as described for the first grafted layer.

### EXAMPLE 7

Layer by Layer Hydrophilic and Hydrophobic Polymer-Silica Composites by Controlled Radical Polymerization (CRP)

1 g of iniferter-modified silica particles, obtained as described in Example 2, was suspended in a polymerization mixture consisting of divinylbenzene (8 mL) dissolved in 10 mL of dry toluene. The polymerization was carried out as described in example 2.

After polymerization the particles were Soxhlet extracted, dried and subsequently immersed in second prepolymerization mixture consisting of HEMA in toluene. Grafting of the second layer was performed as described for the first grafted layer.

### EXAMPLE 8

Layer by Layer Catalytically Active Polymer-Silica Composites by Controlled Radical Polymerization (CRP)

1 g of iniferter-modified silica particles, obtained as described in Example 2, was suspended in a polymerization mixture consisting of HIEMA (8 mL) dissolved in 10 mL of dry toluene. The polymerization was carried out as described in example 2.

After polymerization the particles were Soxhlet extracted, dried and subsequently immersed in second prepolymerization mixture consisting of monomers, solvent and a template yielding a catalytically active site. Grafting of the second layer was performed as described for the first grafted layer. After extraction of the particles in a Soxhlet apparatus and drying a third hydrophobic layer was grafted by immersing them in a prepolymerization mixture consisting of divinylbenzene in toluene. Grafting of the third layer was performed as described for the first grafted layer.

After extraction and drying the template was removed resulting in a catalytically active site sandwiched between a hydrophilic and a hydrophobic layer.

### EXAMPLE 9

The composites according to Examples 1-8 were prepared using nonporous silica particles, monolithic silica or on flat substrates (e.g. microscope slides) as disposable supports.

### EXAMPLE 10

Generation of the Thin Walled Polymers from Composites According to Examples 1-9

Portions of the composite materials prepared according to examples 1-9 were suspended in NH₄HF₂ (aq.) in Teflon flasks. The suspensions were shaken at room temperature for 2 days resulting in the removal of the silica.

### EXAMPLE 11

Generation of Thin Walled Polymers by Interfacial Controlled Radical Polymerization

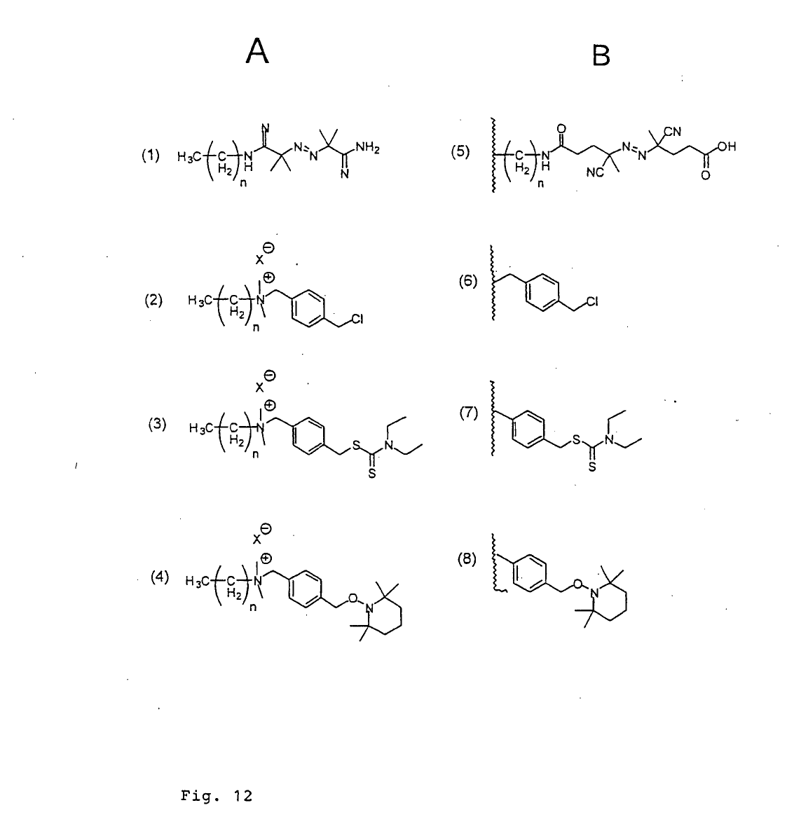

The amphiphilic initiator (1) (see FIG. 12) (0.1 mmol), RAFT agent (2-phenylprop-2-yl-dithiobenzoate) (0.2 g) was mixed with DTAB (decyltrimethylammoniumbromide) (1 mmol) in 20 mL water containing methacrylamide (5 mmol), methylenbisacrylamide (20 mmol) and a template. To the solution was added 200 mL toluene. The resulting two phase system was vortexed and -irradiated with a medium pressure mercury UV lamp for 2 hours. The resulting particles were filtered and washed. A second polymer layer could be grafted on top of the first analoguosly to Example 8.

### EXAMPLE 12

Use of Thin Walled MIPs According to Example 10 or 11 for Selective Separations.

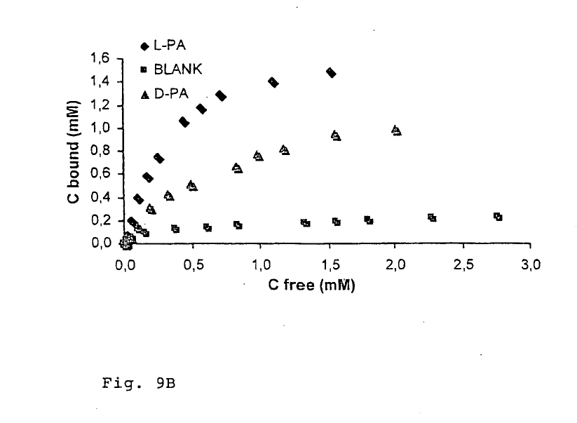

Adsorption isotherms for the thin-walled MIPs and iniferter composites were obtained by adding incremental amounts of each enantiomer to a given amount of polymer. After equilibration, the concentrations of free enantiomer in the supernatant solutions were measured; the concentration of the adsorbed enantiomer is then obtained by subtraction. FIG. 9 shows the adsorption isotherms of D- and L-phenylalanine anilide that were obtained for the adsorption on an L-PA imprinted thin walled MIP and a corresponding non-imprinted gel prepared as described in Example 2, 3 and 10.

### EXAMPLE 13

Use of Thin Walled MIPs According to Example 10 or 11 for Stimulus Responsive Functions

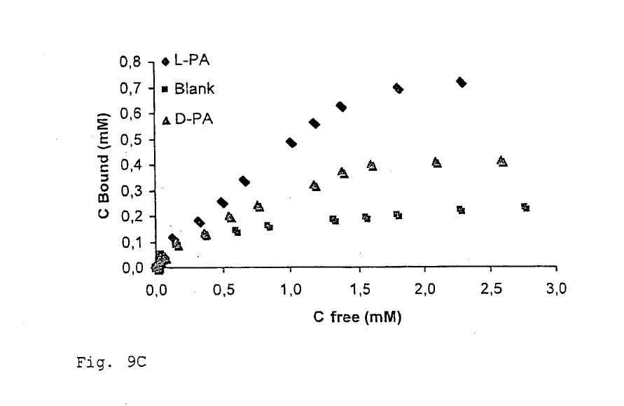

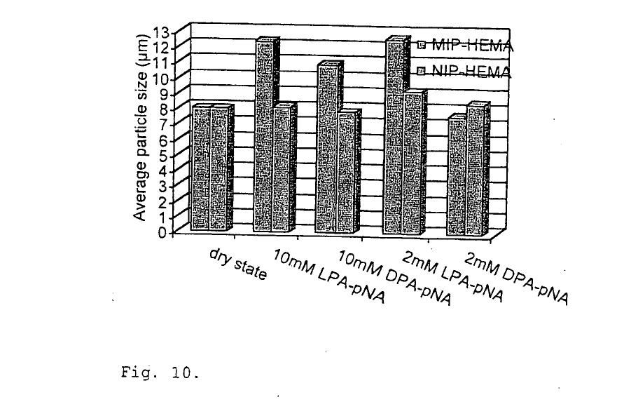

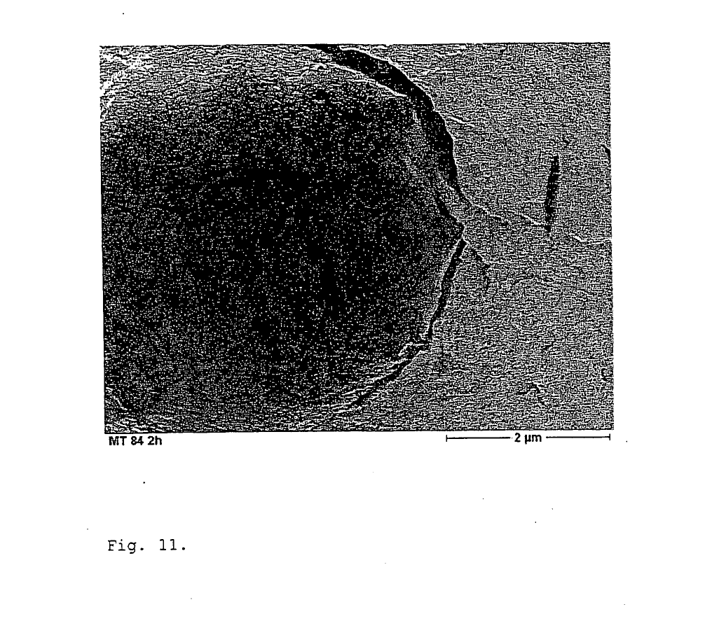

An enantioselective swelling was observed by adding incremental amounts of each enantiomer to a given amount of polymer prepared as described in Example 2 and 10 (FIG. 10). After equilibration, the swelling factor (bed volume of swollen polymer/bed volume of dry polymer) was measured for the imprinted and non-imprinted polymers. This shows that the gels swelled considerably more when adding the enantiomer corresponding to the template than when adding the opposite enantiomer. This can be used to develop chemically smart delivery systems, in chemical sensors or in actuators. FIG. 11 shows a cross section of a thin walled polymer particle in the dry state.

### EXAMPLE 14

Use of Thin Walled MIPs According to Example 8 and 10 or 11 to Catalyze a Chemical Transformation

A catalyst capable of catalyzing the enantioselective hydrolysis of an ester or amide was incorporated in the middle layer. The trilayered gels resulted in a high activity in the hydrolysis of esters or amides when suspended in a liquid-liquid two phase system. The reverse reaction (condensation) could also be catalyzed from the corresponding alcohol (or amine) and acid.

### EXAMPLE 15

Use of Thin Walled MIPs According to Example 6, 7 and 10 or 11 to Facilitate the Transfer of a Compound Between Two Liquid Phases

The gels obtained from Examples 6, 7 and 10 were suspended in a liquid-liquid two phase system. Partitioning of a compound between the two phases was faster in presence of the gels than in their absence. Interfacial reactions were in general strongly accelerated.
¹ J. Pyun and K. Matyjaszewski, Chem. Mater., 2001, 13, 3446.
² S. A. Johnson, P. J. Ollivier, and T. E. Mallouk, Science, 1999, 283, 963.
³ O. Prucker and J. Rühe, Macromolecules, 1998, 31, 592.
⁴ B. Sellergren, B. Rückert, and A. J. Hall, Adv. Mat., 2002, 14, 1204.
⁵ H.-P. Hentze and M. Antonietti, Current Opinion in Solid State and Materials Science, 2001, 5, 343.
⁶ M. M. Titirici, A. H. Hall, and B. Sellergren, Chem. Mater., 2002, 14, 21.
⁷ T. K. Mandal, M. S. Fleming, and D. S. Walt, Chem. Mater., 2000, 12, 3481.
⁸ M. Watanabe, T. Akahoshi, Y. Tabata, and D. Nakayama, J. Am. Chem. Soc., 1998, 120, 5577.
⁹ B. Sellergren, Angew. Chem. Int. Ed., 2000, 39, 1031.
¹⁰ C. Sulitzky, B. Rückert, A. J. Hall, F. Lanza, K. Unger, and B. Sellergren, Macromolecules, 2002, 35, 79.
¹¹ M. M. Titirici, A. J. Hall, and B. Sellergren, Chemistry of Materials, 2003, 15, 822.
¹² B. Rückert, A. J. Hall, and B. Sellergren, J. Mat. Chem., 2002, 12, 2275.

1-27. (canceled)

28. A non-supported (or free standing) imprinted polymer film characterized in that it is obtainable by polymerization of one or several monomers and templates at an interphase between two immiscible liquids or at the liquid-gas, solid-gas or solid-liquid interphase, whereafter at least one of the phases is removed exposing a new adsorptive surface of the film.

29. The polymer film according to claim 28, wherein said polymerization is initiated by grafting under controlled radical polymerization conditions (CRP).

30. The polymer film according to claim 29, characterized in that it is obtained by the “grafting to” technique whereby the polymerization is initiated in solution and growing radicals are attached to an interface by addition to interface pendent double bonds.

31. The polymer film according to claim 29, characterized in that it is obtained by the “grafting from” technique whereby the polymerization is started at an interface by interface immobilized initiator species or in situ generated radicals.

32. The polymer film according to claim 29, characterized in that the CRP is performed by atom transfer radical polymerization (ATRP), relying on redox reactions between alkyl halides and transition metal complexes.

33. The polymer film according to claim 29, characterized in that the CRP is performed by stable free radical polymerization (SFRP) making use of initiators or iniferters decomposing to one initiating radical and one stable free radical.

34. The polymer film according to claim 33, characterized in that the initiators are chosen from nitroxides such as 2,2,6,6,-tetramethylpiperidinyloxy and the iniferters are chosen from dithiocarbamates or dithiuram disulfides.

35. The polymer film according to claim 29, characterized in that the CRP is performed by degenerative chain transfer, based on the use of conventional initiators and highly active transferable chain end capping groups, the latter used in radical addition fragmentation chain transfer (RAFT) polymerization.

36. The polymer film according to claim 28, characterized in that the conventional initiators are chosen from azo-based initators like AIBN or CPA and that the highly active transferable chain end capping groups are chosen from dithioesters.

37. The polymer film according to claim 28, characterized in that the interphase is that formed by mixing a hydrophilic phase with a hydrophobic phase.

38. The polymer film according to claim 28, characterized in that the interphase is that formed by mixing an aqueous phase with a nonmiscible organic solvent, an aqueous phase with another aqueous phase made nonmiscible by the use of additives (e.g. polyethyleneglycols and dextranes) or that formed by mixing two nonmiscible organic solvents.

39. The polymer film according to claim 28, characterized in that the interphase ia those formed by mixing a liquid with a gas.

40. The polymer film according to claim 28, characterized in that the interphase is that between a solid and a liquid or a gas phase where the solid phase may consist of porous or non-porous, inorganic or organic materials.

41. The polymer according to claim 40, characterized in that the inorganic materials are solids such as oxides based on silicon (e.g. silica porous glass), titanium, aluminum (alumina), zirconium.

42. The polymer according to claim 40, characterized in that the organic materials are organic materials such as network organic polymers e.g. those based on polymethacrylates, polyacrylates, polystyrene or biopolymers (e.g. agarose or dextran).

43. The polymer according to claim 40, characterized in that the solid phase is planar such as flat surfaces based on silicon (oxidized or non-oxidized), glass, MICA, gold or other metal surfaces.

44. The polymer film according to claim 40, characterized in that the solid phase is removed by base hydrolysis or fluoride treatment (e.g. for silica).

45. The polymer film according to claim 40, characterized in that the solid phase is porous silica which is used as a mould and that a template is immobilized to the walls of the mould or dissolved in the monomer mixture, the pores are filled with a monomer/template/initiator mixture, and after polymerization the silica is etched away and imprinted polymer beads are obtained exhibiting molecular recognition properties.

46. The polymer film according to claim 45, characterized in that the template is at least one type of small molecule, macromolecule, macromolecular assembly or cell, such as ions, amino acids, DNA bases, drugs, pesticides, peptides, carbohydrates, proteins, antibodies, antigens, nucleic acids, viruses, microorganisms or crystals.

47. The polymer film according to claim 29, characterized in that
a. one first monomer system is grafted with one first template,
b. the first template is removed,
c. a second monomer system is grafted using a second template
d. the second template is removed,
e. the solid phase is removed exposing an innermost first grafted layer.

48. The polymer according to claim 47, characterized in that several monomer systems are being used.

49. The polymer according to claim 28, characterized in that at least one monomer system is hydrophilic or at least one monomer system is hydrophobic.

50. The polymer according to claim 28, characterized in that at least one catalytically active group or catalytically active site is incorporated in the polymerized monomers.

51. A method for producing an imprinted polymer film, characterized in that controlled radical polymerization (CRP) is used to produce a thin film cross-linked polymer at an interface between two immiscible liquids or at a liquid-gas, solid-gas or solid-liquid interphase, whereafter at least one of the phases is removed exposing a new adsorptive surface of the film.
